(19) United States
(12) Patent Application Publication
(10) Pub. No.: US 2007/0205042 A1
(43) Pub. Date: Sep. 6, 2007

(54) APPARATUS AND METHOD FOR GENERATING A SEISMIC SIGNAL

(76) Inventors: Doug Temple, Dickinson, TX (US); John Bennett, Texas City, TX (US)

Correspondence Address: WILLIAM E. SCHMIDT, P.C., 9014 STERLINGAME DRIVE, HOUSTON, TX, 77031, US

(21) Appl. No.: 11/673,374

(22) Filed: Feb. 9, 2007

Related U.S. Application Data
(60) Provisional application No. 60/772,457, filed on Feb. 10, 2006.

(51) Int. Cl. G01V 1/04

(52) U.S. Cl. 181/121

(57) ABSTRACT

A seismic signal generating system comprises a hammer positionable to impact a baseplate assembly. An actuator acts cooperatively with the hammer to urge the hammer to impact the baseplate assembly. A friction brake is actuated to impart a friction force to the hammer. The friction force restrains motion of the hammer until the brake is released. A method of generating a seismic signal comprises coupling a hammer to an actuator. The hammer is restrained from motion using a friction brake. The friction brake is released such that the actuator urges the hammer into contact with a baseplate assembly generating a seismic signal.

### CROSS-REFERENCE TO RELATED APPLICATIONS

This application claims priority from U.S. Provisional Application Ser. No. 60/772457 filed on Feb. 10, 2006, which is incorporated herein by reference.

### BACKGROUND

1. Field of the Invention

The present invention relates to the field of seismic data acquisition and more particularly to seismic signal generating devices and their methods of use.

2. Background Information

Seismic geophysical surveys are used in petroleum, gas mineral and water exploration to map the following: stratigraphy of subterranean formations, lateral continuity of geologic layers, locations of buried paleochannels, positions of faults in sedimentary layers, basement topography, and others. Such maps are deduced through analysis of the nature of reflections and refractions of generated seismic waves from interfaces between layers within the subterranean formation.

A seismic energy source is used to generate seismic waves that travel through the earth and are then reflected by various subterranean formations to the earth's surface. As the seismic waves reach the surface, they are detected by an array of seismic detection devices, known as geophones, which transduce waves that are detected into representative electrical signals. The electrical signals generated by such an array are collected and analyzed to permit deduction of the nature of the subterranean formations at a given site.

An impact source is a weight striking the surface of the earth directly or impacting a plate placed on the earth's surface, yielding seismic energy. A weight-drop is an example of a type of impact source. The actuation time of common impact sources varies between actuations This variation may cause problems in synchronizing a source with seismic receivers to obtain the most useful data. In addition, the use of multiple sources is desirable to increase the generated seismic signal. The variation of actuation times of multiple units may degrade the transmitted signal such that the received data is of marginable use.

### SUMMARY

In one aspect of the present invention, a seismic signal generating system comprises a hammer positionable to impact a baseplate assembly. An actuator acts cooperatively with the hammer to urge the hammer to impact the baseplate assembly. A friction brake is actuated to impart a friction force to the hammer. The friction force restrains motion of the hammer until the brake is released.

In another aspect, a method of generating a seismic signal comprises coupling a hammer to an actuator. The hammer is restrained from motion using a friction brake. The friction brake is released such that the actuator urges the hammer into contact with a baseplate assembly generating a seismic signal.

In yet another aspect, a seismic acquisition system comprises a plurality of seismic signal generating systems disposed proximate each other. A friction brake is disposed with each of the plurality of seismic signal generating systems for releasing a hammer to generate a seismic signal. A plurality of controllers are associated with the plurality of seismic signal generating system. Each controller controls the release of the friction brake in the associated seismic signal generating system. Each controller stores in a memory disposed therein a system response time of the associated seismic signal generating system. A master controller is spaced apart from the plurality of seismic signal generating systems, and receives data related to the response time of each seismic signal generating system. The master controller determines a delay time for actuating each seismic signal generating system such that each of the seismic signal generating systems generates the seismic signal within a predetermined time period.

Non-limiting examples of certain aspects of the invention have been summarized here rather broadly, in order that the detailed description thereof that follows may be better understood, and in order that the contributions they represent to the art may be appreciated. There are, of course, additional features of the invention that will be described hereinafter.

### BRIEF DESCRIPTION OF THE FIGURES

For a detailed understanding of the present invention, references should be made to the following detailed description of the exemplary embodiment, taken in conjunction with the accompanying drawings, in which like elements have been given like numerals, wherein:

FIG. 1 shows system components of one example of the present invention with a partial section elevation view of an illustrative example of a seismic impact source;

FIG. 2 shows a section view of a brake assembly;

FIG. 3 shows a section view of a baseplate assembly;

FIG. 4 shows a view of a tiltable seismic source according to one embodiment of the present invention;

FIG. 5 shows an illustrative example of a seismic data gathering system including multiple seismic impact sources; and

FIG. 6 shows a section view of a seismic source and baseplate assembly positioned on an inclined surface.

### DETAILED DESCRIPTION

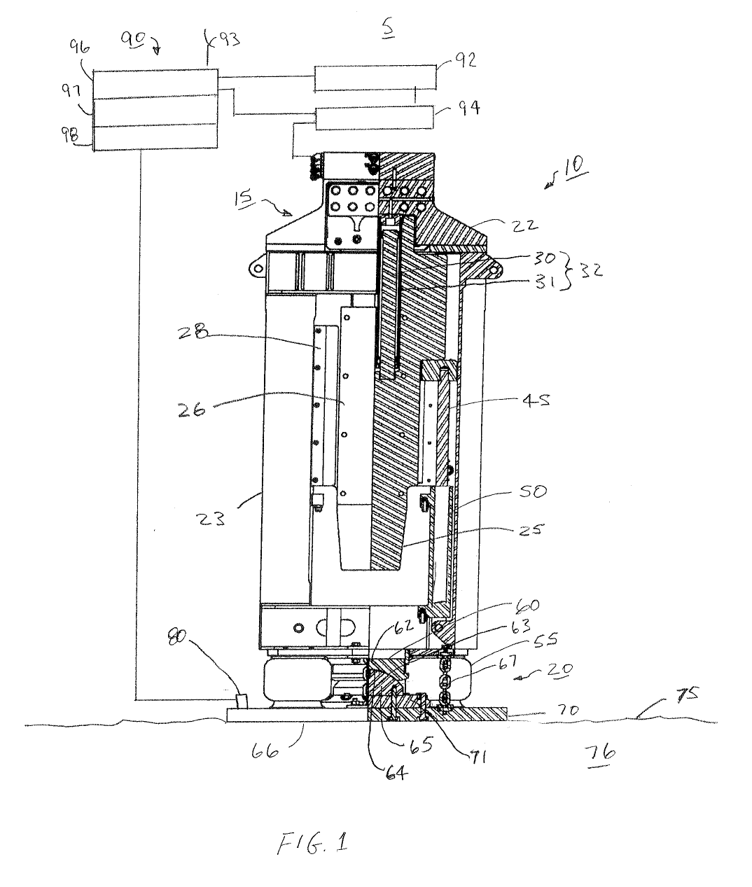

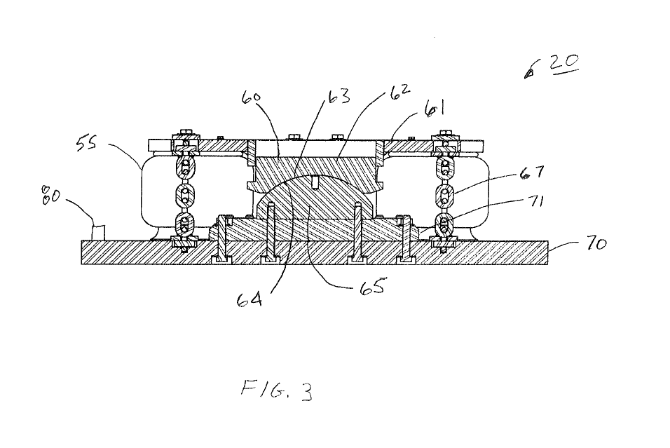

The following description presents non-limiting examples of embodiments of the present invention. Referring initially to FIG. 1-3, in one illustrative embodiment of the present invention, a seismic signal generating system 5 comprises an impact source 10 located on earth surface 75, hydraulic source 92 supplies hydraulic fluid through hydraulic manifold 94 to seismic impact source 10 under control of a controller 90.

Seismic impact source 10 comprises a frame 23 having a friction brake assembly 15 and a baseplate assembly 20 described in more detail below. Friction brake assembly 15 is mounted atop frame 23 and restrains the motion of hammer 25 until breaking action is released. When released, hammer 25 is driven downwards by a gas spring 32 and forced to strike impact surface 60. The impact signal generated by the striking of impact surface 60 by hammer 25 is transmitted through the components of baseplate assembly 20 into the surface 75 of the earth 76. This impulse signal is then transmitted through the earth strata and detected by seismic receivers on the surface of the earth. Alternatively, seismic receivers may be positioned either temporarily or permanently in a subterranean well. Such a well may be vertical, inclined, or horizontal.

In one embodiment gas spring 32 comprises spring rod 30 attached to hammer 25 and cylinder 31 attached to caliper 22. High pressure gas is stored in cylinder 31 at a predetermined pressure. The high pressure gas is compressed to an even higher pressure when spring rod 30 is pushed upward to a cocked position. In one embodiment, the high pressure gas is dry nitrogen. Alternatively, any suitable substantially inert gas may be used, such as argon. The pressure in the cocked position may reach several thousand pounds per square inch. This pressure acts on spring rod 30 to impart a force acting downward on spring rod 30. When the brakes in friction brake assembly 15 are released, the gas pressure on spring rod 30 and the force of gravity act to accelerate hammer 25 toward baseplate assembly 20. While described herein is using a gas spring, it is intended that the present invention encompass any suitable spring type. Such springs include, but are not limited to, hydraulic springs, coil springs, and elastomer springs.

Hammer 25 is made of a metallic material such as steel and provides the weight used to generate a portion of the impact force. Hammer 25 may weigh several hundred to several thousand pounds. Additional weight may be added to the hammer by attaching add on weight 26 to hammer 25. The motion of hammer 25 is closely guided by guide plates 28. Guide plates 28 may be made from a suitable plastic material. Such plastic materials include but are not limited to: nylon, teflon, and any other suitable material.

After hammer 25 generates a seismic signal by striking impact surface 60, hammer 25 may be returned to its cocked position by the action of hydraulic cocking cylinder 50 and cocking rod 45. Cocking cylinder 50 may be operated under control of controller 90.

Baseplate assembly 20 comprises a striker pivot 62 contacting a lower pivot 65. Lower pivot 65 is mounted on intermediate plates 71 which is in turn mounted on baseplate 70. Striker pivot 62 has an upper impact surface 60 which is contacted by hammer 25. Striker pivot 62 has a lower concave surface 63 that substantially mates with convex surface 64 of lower pivot 65. Both concave surface 63 and convex surface 64 may each be substantially spherical. The substantially spherical shape of these surfaces is advantageous in the transmission of the seismic signal from impact surface 60 to baseplate 70. In one aspect, the substantially spherical nature of the mating surfaces provides an increased contact area for the transmission of the seismic signal. Both striker pivot 62 and lower pivot 65 may be made from metallic materials including, but not limited to: aluminum bronze, aluminum, steel, and beryllium copper.

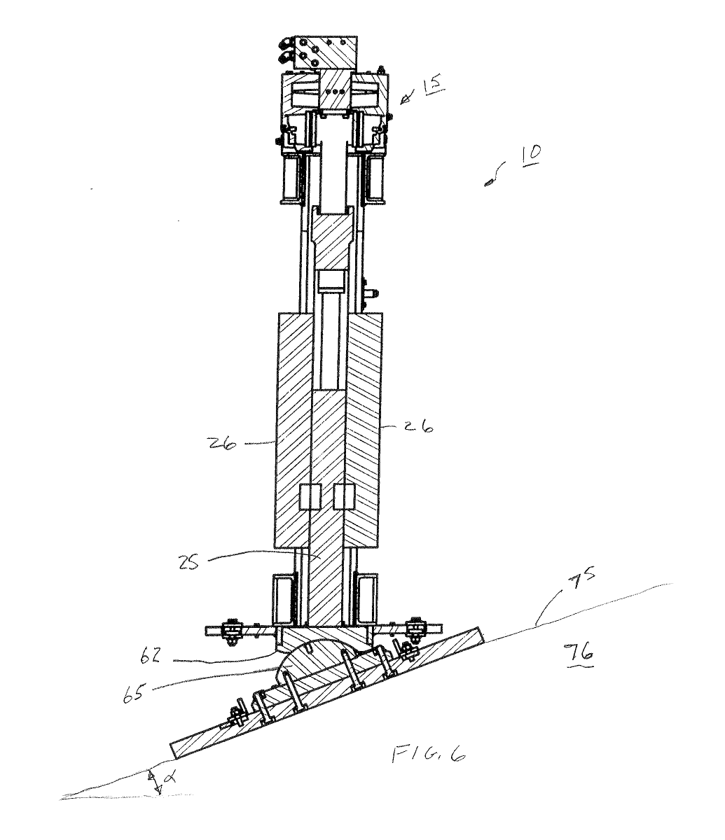

As shown in FIG. 6, in another aspect, the substantially spherical nature of the mating surfaces allows a certain amount of angularity between the baseplate 70 and the top plate 61 due, in one example to uneven ground. As shown, the earth's surface 75 is at an angle, α, with respect to true horizontal. The substantially spherical nature of striker pivot 62 and lower pivot 65 allow the hammer 25 to be operated in a substantially vertical orientation thereby maximizing the gravitational acceleration on hammer 25 during the hammer strike.

Multiple air bags 55 are attached between baseplate 70 and top plate 61. Air bags 55 operate to isolate the frame mounted components from the shock associated with the hammer strike. Such airbags are commercially available and are not discussed here further. Chain 67 acts to restrain the downward motion of baseplate 70 with respect to top plate 61 during a hammer strike.

In one embodiment, sensor 80 is attached to baseplate 70 and may be used to characterize the seismic signal transmitted through baseplate 70. Sensor 80 may also be used to characterize the response time of seismic impact source 10 with respect to an initiation signal from controller 90. Sensor 80 may be an accelerometer or any other device having suitable amplitude and frequency range to characterize the seismic signal transmitted through baseplate 70. Such accelerometers are commercially available and will not be discussed here in detail.

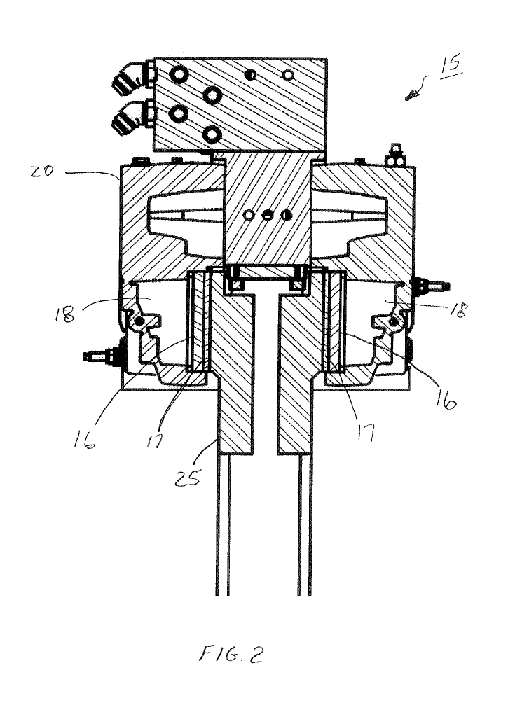

As shown in FIG. 1 and 2, friction brake assembly 15 comprises caliper 20, brake pistons 16, and brake pads 17. As shown in FIG. 2, opposing sets of brake pistons 16 and brake pads 17 are employed in the present example. When hammer 25 is in the upward cocked position, hydraulic fluid in reservoir 18 is pressurized to force brake piston 16 against brake pad 17 which in turn contacts hammer 25 creating a friction force to restrain motion of hammer 25. When hydraulic pressure in reservoir 18 is released, gas spring 32 and the force of gravity accelerate hammer 25 to impact with baseplate assembly 20. This technique results in a quick, reliable, and repeatable release mechanism. The present embodiment employs two pairs of opposed brake pads 17 and brake pistons 16, acting against opposite sides of hammer 25. Other numbers of pairs of opposed brake pads and brake pistons may be used. Alternatively, a floating caliper may be employed wherein pistons are on only one side of the caliper.

Controller 90 may comprise circuits 96, a processor 97, and computer readable medium 98. Computer readable medium 98 may be any suitable storage medium including, but not limited to, RAM, ROM, CD, hard disk, DVD, flash memory, and any other suitable medium not yet developed. Instructions may be stored in computer readable medium 98 for execution by processor 97 for controlling the operation of seismic impact source 10. Controller 90 may be programmed to control power source 92 and valve manifold 94 to control the operation of seismic impact source 10. Such control may be used to operate the friction brake 15 and cocking cylinder 50 during operation. Controller 90 may also include suitable circuits and hardware, such as antenna 93, for transmitting and receiving data and instructions from a remote master controller as described below.

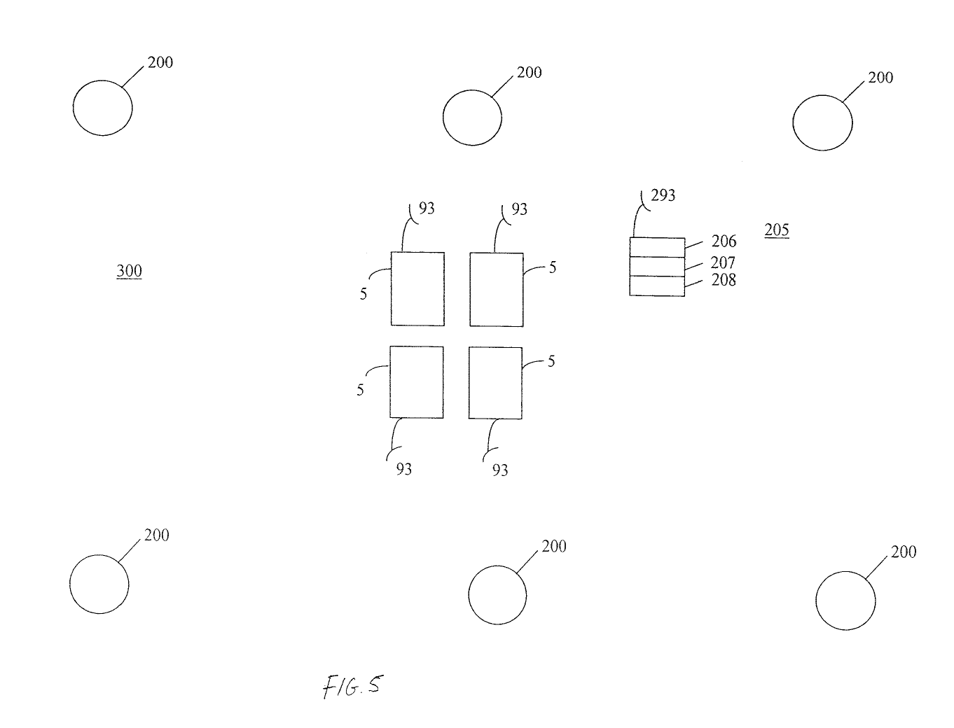

Controller 90 may comprise suitable circuits 96 and instructions stored in computer readable medium 98 for processing signals from sensor 80. In one illustrative example, signals from sensor 80 may be used to characterize the impact seismic signal generated during operation a seismic source 10. Such signals may be analyzed or both amplitude and frequency content and monitored over time to determine changes in system operation. In another illustrative example, signals from Sensor 80 may be used to characterize the response time of each seismic source 10. For example, the components of each seismic impact source 10 may vary in their individual response. In order to determine the system response, the time between initiation signal from controller 90 until the hammer impacts the baseplate assembly may be determined. It is anticipated that each seismic source 10 will have a slightly different response time. This system response time may be used to coordinate multiple sources as described below with regard to FIG. 5.

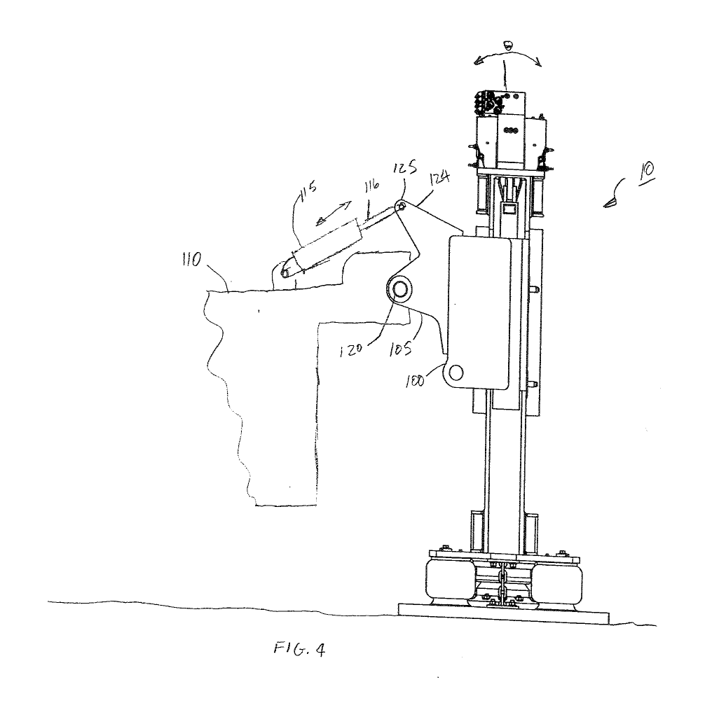

Referring also to FIG. 4, in one illustrative example seismic impact source 10 has frame 100 attached thereto. Frame 100 may be attached to seismic source 10 using a mechanical technique known in the art. Frame 100 as arm 105 attached thereto. Arm 105 has pivot axle 120 that facilitates attachment of frame 100 to support vehicle 110. Arm 105 also has crank arm 124 integral thereto. Cylinder 115 with associated cylinder rod and 116 are attached between support vehicle 110 and pivot point 125 on crank arm 124. Cylinder 115 may be actuated to extend and retract cylinder rod 116 such that seismic source 10 moves through an angle θ with respect to the vertical as shown. Such angular movement may be used to accommodate uneven ground as shown in FIG. 6. Alternatively, such angular movement to be used to impart a shear wave through baseplate assembly 20 into the earth. As discussed previously, the spherical surfaces of striker pivot 62 and lower pivot 65 are well suited to accommodate such angular movement.

Referring also to FIG. 5, in one embodiment, a seismic system 300 may comprise multiple seismic signal generating systems 5 in synchronous operation to generate a larger seismic signal. Each of the seismic signal generating systems 5, as described previously comprises its own controller 90. As shown in FIG. 5, a master controller 205 may comprise circuits 206, a processor 207, and computer readable medium 208. Multiple seismic receivers 200 may be located in suitable patterns away from the seismic source for detecting the seismic signal transmitted through the earth.

As described previously, computer readable medium 208 may be any suitable storage medium including, but not limited to, RAM, ROM, CD, hard disk, DVD, flash memory, and any other suitable medium not yet developed. Instructions may be stored in computer readable medium 208 for execution by processor 207 for controlling the operation of seismic system 300.

Master controller 205, may be remotely located from the cluster of seismic signal generating systems 5. Transmission of data and command signals between controllers 90 and master controller 205 may be by wired or wireless communication techniques. Wireless communication techniques include but are not limited to radio frequency transmission, infrared transmission, optical transmission, and microwave transmission. Wired communication techniques include electrical conductor and fiber optic transmissions. Master controller 205 may also transmit data and receive commands from another remote location.

As one skilled in the art will appreciate, when actuating multiple impact devices such as seismic signal generating systems 5, it is desirable that the signals from each device be generated at substantially the same time. In real-world operation, sufficient received signal resolution may be achieved if the multiple impact devices generate seismic signals within less than a predetermined time interval of no more than about 2 ms. In one example of the present invention, master controller 205 uses data related to the response time of each seismic signal generating system 5 to synchronize the signal generated by each seismic signal generating system 5 within the predetermined time interval. Each seismic signal generating system 5 may determine its response time after each generated signal. Controllers 90 may then transmit the latest determined response time to master controller 205 for use in the next generated signal. In one example, master controller 205 may determine the largest response time and determine a delay time for actuating each of the other signal generating systems such that they all generate a seismic signal at substantially the same time within the predetermined interval. Alternatively, controller 90, on each individual seismic signal generating system 5, may only transmit changes in the response time to master controller 205. Master controller 205 will then adjust the delay time of a particular seismic signal generating system 5 based on its changed response time.

While the foregoing disclosure is directed to the non-limiting illustrative embodiments of the invention presented, various modifications will be apparent to those skilled in the art. It is intended that all variations within the scope of the appended claims be embraced by the foregoing disclosure.

What is claimed is:

1. A seismic signal generating system, comprising:
a hammer positionable to impact a baseplate assembly;
an actuator acting cooperatively with the hammer to urge the hammer to impact the baseplate assembly; and
a friction brake actuatable to impart a friction force to the hammer, the friction force restraining motion of the hammer until the brake is released.

2. The seismic signal generating system of claim 1, wherein the actuator is a gas spring.

3. The seismic signal generating system of claim 1, wherein the friction brake comprises a friction pad hydraulically forced into contact with the surface of the hammer.

4. The seismic signal generating system of claim 1, further comprising a baseplate assembly.

5. The seismic signal generating system of claim 4, wherein the baseplate assembly comprises a striker pivot acting cooperatively with a lower pivot to transmit the seismic signal to the earth when the hammer impacts the striker pivot.

6. The seismic signal generating system of claim 5, wherein the striker pivot comprises a first substantially spherical surface and the lower pivot comprises a second substantially spherical surface wherein the contact of the first surface and the second surface acts to enhance transmission of the seismic signal from the striker pivot to the lower pivot.

7. The seismic signal generating system of claim 5, wherein the striker pivot comprises a first substantially spherical surface and the lower pivot comprises a second substantially spherical surface wherein contact of the first surface and the second surface acts to transmit the seismic signal in the presence of angular misalignment of the striker pivot with respect to the lower pivot.

8. The seismic signal generating system of claim 1, further comprising a controller generating a first signal causing release of the friction brake.

9. The seismic signal generating system of claim 8, wherein the controller comprises a processor and a computer readable medium.

10. The seismic signal generating system of claim 9, further comprising a sensor attached to the baseplate, the sensor detecting the impact of the hammer and generating a second signal related thereto.

11. The seismic signal generating system of claim 10, wherein the controller receives the signal from the sensor and determines a response time of the seismic signal generating system.

12. A method of generating a seismic signal, comprising:
coupling a hammer to an actuator;
restraining the hammer from motion using a friction brake; and
releasing the friction brake such that the actuator urges the hammer into contact with a baseplate assembly generating a seismic signal.

13. The method of claim 12, further comprising detecting the impact of the hammer with the baseplate assembly with a sensor attached to the baseplate assembly and generating a third signal related thereto.

14. The method of claim 13, further comprising controlling the release of the friction brake with a fourth signal from a controller.

15. The method of claim 14, further comprising determining a seismic generating system response time related to the third signal and the fourth signal.

16. The method of claim 12, further comprising enhancing transmission of the seismic signal from the striker pivot to the lower pivot by transmitting the seismic signal through a first substantially spherical surface on the striker pivot contacting a second substantially spherical surface on the lower pivot.

17. A seismic acquisition system comprising:
a plurality of seismic signal generating systems disposed proximate each other;
a friction brake disposed with each of the plurality of seismic signal generating systems releasing a hammer to generate a seismic signal;
a plurality of controllers associated with each seismic signal generating system, each controller controlling the release of the friction brake in the associated seismic signal generating system, each controller storing in a memory disposed therein a system response time of the associated seismic signal generating system; and
a master controller spaced apart from the plurality of seismic signal generating systems, the master controller receiving data related to the response time of each seismic signal generating system, the master controller determining a delay time for actuating each seismic signal generating system such that each of the seismic signal generating systems generate the seismic signal within a predetermined time period.

18. The seismic acquisition system of claim 17, wherein the predetermined time period is no greater than about 2 milliseconds.

19. The seismic acquisition system of claim 17, wherein the master controller transmits a delayed actuation signal to each of the plurality of controllers using a wireless transmission technique chosen from the group consisting of: a radio frequency transmission, an infrared transmission, an optical transmission, and a microwave transmission.

20. The seismic acquisition system of claim 17, wherein each of the plurality of controllers determines a delay time for the associated seismic signal generating system and transmits the delay time to the master controller.
